(19) United States
(12) Patent Application Publication
(10) Pub. No.: US 2024/0295208 A1
(43) Pub. Date: Sep. 5, 2024

(54) ENERGY CONVERTER FOR OCEAN WAVES AND METHOD FOR USING THEREOF

(71) Applicant: HAVKRAFT AS, DEKNEPOLLEN (NO)

(72) Inventor: Geir Arne Solheim, DEKNEPOLEN (NO)

(73) Assignee: HAVKRAFT AS, DEKNEPOLLEN (NO)

(21) Appl. No.: 18/573,505

(22) PCT Filed: Jun. 20, 2022
(86) PCT No.: PCT/IB2022/055702

§ 371 Date: Dec. 22, 2023

(30) Foreign Application Priority Data
Jun. 29, 2021 (GB) 2109348.9

(51) Int. Cl. F03B 13/14; F03B 13/24

(52) U.S. Cl. CPC F03B 13/142; F03B 13/24; F05B 2240/93

(57) ABSTRACT

An energy converter is provided for converting an energy of ocean waves received at the energy converter into corresponding electrical energy. The energy converter includes a buoyant platform having a peripheral edge region. One or more wave energy conversion devices are mounted around at least a portion of the peripheral edge region. The buoyant platform together with its one or more wave energy conversion devices are configured to exhibit at least one of a roll movement and a pitch movement when in use. Herein, natural resonant frequencies of at least one of the movements are matchable to a frequency of the ocean waves received at the energy converter and the one or more wave energy conversion devices are configured to convert the energy of the ocean waves into air movements to drive a generator arrangement to generate electrical energy.

### TECHNICAL FIELD

The present disclosure relates generally to energy converters for converting energy of ocean waves received thereat into corresponding electrical energy. Moreover, the present disclosure relates to a method for using an energy converter comprising one or more wave energy conversion devices for converting an energy of ocean waves received thereat into electrical energy. More specifically, the present disclosure relates to an energy converter that is configured to absorb ocean waves received thereat to generate corresponding air movements that are supplied to one or more wave energy conversion devices of the energy converter to generate corresponding electrical energy.

### BACKGROUND

Renewable sources of energy are preferred over non-renewable sources of energy for reasons of long-term sustainability; such renewable sources of energy are environmentally friendly and abundantly available in nature. “Peak oil” in respect of fossil fuels is now becoming recognized as a major challenge to contemporary industrial society that consumes circa 100 million barrels of oil-equivalent per day. Moreover, anthropogenically-forced climate change results from increased concentrations of carbon dioxide in atmosphere (presently circa 430 p.p.m. and rising at 2 to 3 p.p.m./year). With circa 350, 000 tonnes of high-level nuclear waste worldwide generated during the past circa 60 years from contemporary fission nuclear reactors, nuclear power is also not sustainable in the long term.

Wave energy converters are known in the art and employ a variety of wave energy conversion mechanisms. However, unlike offshore wind turbines, ocean wave energy converters have not hitherto been deployed in large numbers for providing electrical power to electrical supply networks.

A contemporary challenge is to implement aforesaid ocean wave energy converters in a cost-effective manner, whilst ensuring that they convert ocean wave energy efficiently to electrical power and also survive severe weather conditions which are occasionally encountered offshore. There are challenging associated constraints which can be mutually opposing; for example, a robust design of ocean wave converter is potentially more costly to manufacture and deploy in comparison to a less-robust structure. A further technical challenge is that electrical generators require rapidly rotating parts to generate electricity energy efficiently from changing magnetic fields, whereas ocean waves exhibit slow reciprocating movements; as a result, matching such slow wave motion to rapidly rotating electrical generator components requires complex and costly coupling mechanisms, whereas wind turbines are efficient at converting air flows into rapidly rotating movements of electrical generator components via use of a gearbox between associated turbine and generator.

Contemporary known wave power stations are effectively point absorbers in that their converters convert wave energy received spatially locally thereat to corresponding electrical energy; often, mechanical operating characteristics of the converters are poorly matched to a propagation impedance of ocean waves received thereat, resulting in a poor wave absorption performance. Thus, such known wave power stations have high costs and a poor conversion efficiency. A robust and efficient wave energy converter is described in a published international PCT patent application no. WO2011/162615A2 (PCT/NO2011/000175, “Ocean Wave Energy System”, Havkraft A S, Geir Solheim) which is hereby incorporated by reference. The wave energy converter is implemented as an ocean wave energy system for generating power from ocean waves, wherein the system includes a platform supporting an array of hollow columns whose respective lower ends are in fluidic communication with ocean waves and whose respective upper ends are in air communication with a turbine arrangement such that wave motion occurring at the lower ends is operable to cause air movement within the columns for propelling the turbine arrangement to generate power output. The system further includes one or more position-adjustable and/or angle-adjustable submerged structures near the lower ends of the columns for forming ocean wave propagating in operation towards the lower ends of the columns to couple the waves in a controllable manner into the hollow columns.

In the aforesaid published PCT application no. WO2011/162615A2, there is provided a comprehensive overview of wave energy theory which is hereby incorporated by reference. Although there are many similarities between electromagnetic wave propagation and ocean wave propagation, there are major differences on account of ocean waves having mass and being subject to fluid flow effects. Ocean waves are surface waves substantially at an interface between two fluids, namely ocean water and air. The surface waves propagate substantially within a plane of the interface and are susceptible to being refracted, reflected, transmitted and absorbed at any objects intersecting substantially with the plane of the interface. For the surface waves to be absorbed effectively, the objects must be wave impedance matched to an impedance of the surface waves. When the objects are of a physical size comparable to a wavelength of the surface waves, designing the objects to provide an effective wave impedance match is a complex task, especially when the surface waves in practice have a varying wavelength depending upon ocean weather conditions. In addition, the objects need to be designed to withstand severe storm conditions and also be substantially free of cavitation effects when large amounts of wave energy are being absorbed by the objects. The aforesaid published PCT application describes a wave energy converter which is capable of providing efficient absorption of ocean waves.

However, it will be appreciated that waves conditions encountered in a given ocean environment may not be always temporally constant. Sometimes, ocean waves propagating in the given ocean environment may have a large magnitude (“swell”) with associated high wave energy. Conversely, at other times, ocean waves propagating in the given ocean environment may have small magnitude and have correspondingly lower wave energy; in such a case, the electrical energy extracted by traditional wave power stations may be negligible. Moreover, such situations may force users to switch to other electrical energy generation techniques. Thus, there is a great need to improve an efficiency of conversion in wave power stations to reach competitive levelized cost of energy (LCOE) and return on investment (ROI).

Therefore, in light of the foregoing discussion, there still exists a need to implement a wave energy converter which is more efficient when absorbing ocean wave energy to generate electrical energy, while also being robust in operation.

### SUMMARY

An object of the present disclosure is to provide an improved energy converter for converting an energy of ocean waves received at the energy converter into corresponding electrical energy. Another object of the present disclosure is to provide an improved method for using an energy converter for converting energy of ocean waves received at the energy converter into corresponding electrical energy. Another object of the present disclosure is to provide a solution that overcomes at least partially the problems encountered in the aforesaid known techniques.

In one aspect, the present disclosure provides an energy converter comprising one or more wave energy conversion devices implemented for converting an energy of ocean waves received thereat into electrical energy, wherein the energy converter comprises:
a buoyant platform having a peripheral edge region,
wherein:
the one or more wave energy conversion devices are mounted around at least a portion of the peripheral edge region,
the buoyant platform together with its one or more wave energy conversion devices are configured to exhibit at least one of a roll movement and a pitch movement when in use, wherein natural resonant frequencies of at least one of the movements are matchable to a frequency of the ocean waves received at the energy converter, and the one or more wave energy conversion devices are configured to convert the energy of the ocean waves to oscillating water columns and further into air movements to drive a turbine and generator arrangement to generate electrical energy.

In another aspect, an embodiment of the present disclosure provides a method for using an energy converter comprising one or more wave energy conversion devices implemented for converting an energy of ocean waves received thereat into electrical energy, wherein the method comprises:
arranging for the energy converter to include a buoyant platform having a peripheral edge region;
mounting the one or more wave energy conversion devices around at least a portion of the peripheral edge region;
configuring the buoyant platform together with its one or more wave energy conversion devices to exhibit at least one of a roll movement and a pitch movement when in use, wherein natural resonant frequencies of at least one of the roll movement and the pitch movement are matchable to a frequency of the ocean waves received at the energy converter; and
configuring the one or more wave energy conversion devices to convert the energy of the ocean waves to oscillating water columns and further into air movements to drive a turbine and generator arrangement to generate electrical energy.

The present disclosure allows for wave energy that is received from a larger absorption region (namely “surrounding waves”) and not just from incoming waves received at the energy converter; thus, it is feasible to broaden the absorption region substantially in comparison to point absorption to get energy from the surrounding waves, and thereby ensure more efficient generation of electrical energy.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF DRAWINGS

Embodiments of the present disclosure will now be described, by way of example only, with reference to the following diagrams wherein:

FIG. 1 is a schematic diagram of an energy converter for converting an energy of ocean waves received thereat into electrical energy, in accordance with an embodiment of the present disclosure;

FIG. 2 is a diagrammatic illustration of an energy converter, in accordance with an embodiment of the present disclosure;

FIG. 3 is a diagrammatic illustration of an energy converter further including a support structure, in accordance with an embodiment of the present disclosure;

FIG. 4 is a flowchart listing steps involved in a method for using the energy converter for converting energy of ocean waves received thereat into electrical energy, in accordance with an embodiment of the present disclosure;

FIG. 5 is a diagrammatic illustration of a placement of a chamber arrangement and an air flow arrangement, in accordance with an embodiment of the present disclosure;

FIG. 6 is a diagrammatic illustration of a chamber arrangement, in accordance with an embodiment of the present disclosure; and

FIGS. 7A-7K illustrate variations of different performance parameters with respect to time, the different performance parameters being used in computational flow dynamics (CFD) simulations performed for a chamber arrangement of a wave energy conversion device of an energy converter of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, the present disclosure provides an energy converter comprising one or more wave energy conversion devices implemented for converting an energy of ocean waves received thereat into electrical energy, wherein the energy converter comprises:
a buoyant platform having a peripheral edge region,
wherein:
the one or more wave energy conversion devices are mounted around at least a portion of the peripheral edge region,
the buoyant platform together with its one or more wave energy conversion devices are configured to exhibit at least one of a roll movement and a pitch movement when in use, wherein natural resonant frequencies of at least one of the movements are matchable to a frequency of the ocean waves received at the energy converter, and the one or more wave energy conversion devices are configured to convert the energy of the ocean waves to oscillating water columns and further into air movements to drive a turbine and generator arrangement to generate electrical energy.

In another aspect, the present disclosure provides a method for using an energy converter comprising one or more wave energy conversion devices implemented for converting an energy of ocean waves received thereat into electrical energy, wherein the method comprises:
arranging for the energy converter to include a buoyant platform having a peripheral edge region;
mounting the one or more wave energy conversion devices around at least a portion of the peripheral edge region;
configuring the buoyant platform together with its one or more wave energy conversion devices to exhibit at least one of a roll movement and a pitch movement when in use, wherein natural resonant frequencies of at least one of the roll movement and the pitch movement are matchable to a frequency of the ocean waves received at the energy converter; and
configuring the one or more wave energy conversion devices to convert the energy of the ocean waves to oscillating water columns and further into air movements to drive a turbine and generator arrangement to generate electrical energy.

The present disclosure relates to an energy converter for converting an energy of ocean waves received at the energy converter into corresponding electrical energy. Herein, the energy converter may be a device that may convert the wave energy of the ocean wave to the electrical energy. It will be appreciated that the ocean waves are generated when wind forces act upon a surface of an ocean. The ocean waves have the energy that may be referred to as, a wave energy, which decreases exponentially as a function of a depth from the surface of the ocean. Herein, the aforesaid wave energy of the ocean waves may be utilized to generate electrical energy.

The energy converter includes one or more wave energy conversion devices. Herein, the wave energy conversion devices may convert the energy of the ocean waves to the electrical energy. The wave energy conversion devices may, firstly, convert the energy of the ocean waves to mechanical energy which in turn may be converted to the electrical energy. As the number of the wave energy conversion devices used is increased, the efficiency of the energy converter is correspondingly increased. In an embodiment, the wave energy conversion devices may be oscillating water columns (OWCs). As the name suggests, oscillating water column may be used to generate electrical energy by means of oscillation of ocean waves inside an air column such as, a chamber. Such OWCs are beneficial in that they use air coupling that isolates their air-flow driven electrical generators from ocean waves, wherein, like for wind turbines, air flows can be converted efficiently to electrical energy.

Herein, at least one of the one or more wave energy conversion devices includes a chamber arrangement having an open lower end that is submerged when in use in an ocean in which the ocean waves propagate and an open upper end that is located above a surface of the ocean, wherein the open upper end includes an air turbine, such that movements of the surface of the ocean formed within the chamber arrangement causes air movements through the open upper end to drive the air turbine to generate the electrical energy.

Herein, the chamber arrangement may be a hollow air column having two ends, the open lower end and the open upper end. The open lower end of the chamber arrangement may be submerged when in use in the ocean so that the open lower end is in fluidic communication with the ocean waves. The open upper end may include the air turbine and may be located above the surface of the ocean. The air turbine may be a device where the electrical energy is generated by rotation of a rotor due to flowing of air. The air turbine may extract energy carried by the air and may convert it to electrical energy. As the ocean waves oscillate in the chamber arrangement, air movements may be generated in the chamber arrangement through the open upper end which may cause the air turbine to generate the electrical energy.

Optionally, at least one of the one or more wave energy conversion devices may include a chamber arrangement having a first side end, a second side end, an open lower end. The open lower end may be at least partially submerged when in use in an ocean in which ocean waves propagate. The chamber arrangement may also comprise an upper end that is located above a surface of the ocean. The upper end may have at least one opening.

The at least one of the one or more wave energy conversion devices may include an air flow arrangement. The air flow arrangement may comprise a plurality of air ducts. One or more of the air ducts may have an open top end that is exposed to atmosphere, and an open bottom end. An air turbine may be arranged between the open top end and the open bottom end.

The air flow arrangement may be placed on top of the chamber arrangement in a manner that the at least one opening may be fluidically coupled to open bottom ends of the plurality of air ducts. In this way, movements of the ocean waves may produce an oscillating water column within the chamber arrangement thereby generating air movements inside the air flow arrangement to drive air turbines arranged in the plurality of ducts for generating the electrical energy.

Herein, the chamber arrangement may be a hollow air column having the aforementioned ends. Such a hollow air column could be partitioned to provide multiple chambers therein. The open lower end of the chamber arrangement may be submerged when in use in the ocean so that the open lower end is in fluidic communication with the ocean waves. The upper end of the chamber arrangement may be in fluidic communication with a corresponding air duct via the at least one opening. A given air duct may be a hollow enclosure having the open top end, the open bottom end, and the air turbine.

The air flow arrangement and the chamber arrangement may be fabricated separately, and may be joined together via at least one of: bolts, welds, rivets. The air turbine may be a device where the electrical energy is generated by a rotation of a rotor due to flowing of air. A basic principle of working of the air turbine is well-known in the art. The air turbine may extract energy carried by the air and may convert it to electrical energy. As the ocean waves oscillate in the chamber arrangement, air movements may be generated in the air flow arrangement which may cause the air turbine to rotate for generating the electrical energy.

Optionally, the chamber arrangement may comprise a plurality of chambers formed between the first side end and the second side end. The plurality of chambers may have varying depths and being arranged adjacent to each other in an order of increasing depths along a direction from the first side end to the second side end. Each chamber may have a corresponding air duct placed thereon. In this regard, a chamber having a shortest depth may be arranged proximal to the first side end, and a chamber having a greatest depth may be arranged proximal to the second side end of the chamber arrangement. Such an arrangement may facilitate in producing varying oscillating water columns inside the plurality of chambers as the ocean waves can easily propagate inside all chambers (without any hindrance).

Moreover, a given chamber may be associated with a given air turbine such that movements of the ocean waves produce an oscillating water column within the given chamber, and air movements that are generated inside the given chamber drives the given air turbine (for generating the electrical energy). In an example, the chamber arrangement may comprise three chambers C1, C2, and C3 having three air ducts placed thereon.

Optionally, a geometric profile of the open lower end of the chamber arrangement may be one or more of: a linear profile, a step profile, a parabolic profile, a logarithmic profile, a freeform profile. It will be appreciated that any of the aforementioned geometric profile may facilitate in producing varying oscillating water columns inside the plurality of chambers as the ocean waves can easily propagate inside all chambers (without any hindrance) due to such a geometric profile.

Optionally, the energy converter may comprise a plurality of wave energy conversion devices that are arranged along the peripheral edge region of the buoyant platform in form of a one-dimensional (1D) array. In such an array, the second side ends of the chamber arrangements of the plurality of energy conversion devices may be arranged proximal to the buoyant platform. Suitably, the first side ends of the plurality of chamber arrangements may be arranged far from the buoyant platform. In this regard, the plurality of wave energy conversion devices may be arranged adjacent to each other along the peripheral edge region of the buoyant platform.

For a given chamber arrangement of a given wave energy conversion device, a chamber having a greatest depth may be proximal to the buoyant platform, and a chamber having a shortest depth may be far from the buoyant platform. Such an arrangement of chambers may facilitate in producing varying oscillating water columns inside the chambers as the ocean waves can easily propagate inside all the chambers (without any hindrance). Moreover, in such a scenario, an arrangement of chambers may be parallel to an elongate axis (namely, a longitudinal axis) of the buoyant platform.

Optionally, the energy converter may comprise a weight-inducing element for tuning a natural resonant frequency of the buoyant platform. The weight-inducing element may be implemented as at least one of: a damping plate, a ballast tank. Optionally, the damping plate may be arranged in the chamber arrangement. The damping plate may increase an overall weight of the energy converter so that the natural resonant frequency (i.e., natural period) of the buoyant platform in heave and pitch directions may be increased. This can beneficially increase wave energy utilization as there would be considerable (and requisite) relative motion between ocean waves propagating inside the chamber arrangement and the buoyant platform. This may provide a high pressure and a high volume flow of water inside the chamber arrangement, and hence a high electrical power may advantageously be generated. Implementation of the weight-inducing element as the ballast tank has been discussed below.

The energy converter of the present disclosure includes a buoyant platform having a peripheral edge region. Herein, the buoyant platform may be an elongated geometrical structure that may be connected to the one or more wave energy conversion devices, in the energy converter. The term “platform”, as used herein, is defined to mean a decklike construction. The buoyant platform may be made of materials such as, plastic, steel, composites, concrete, aluminium and the like, with a density of the buoyant platform being less than density of the ocean water, so that the buoyant platform floats in the ocean. Herein, the peripheral edge region may be the edges along sides of the buoyant platform.

In the energy converter of the present disclosure, the one or more wave energy conversion devices are mounted around at least a portion of the peripheral edge region. Optionally, the buoyant platform is arranged to be elongate and to have a first end and a second end disposed along an elongate axis, and wherein a first subset of the one or more wave energy devices is clustered at one of the ends substantially along the elongate axis, and a second subset of the one or more wave energy devices is clustered at peripheral sides of the buoyant platform and substantially adjacent to the first subset. Herein, the elongate axis may be along a length of the buoyant platform. With the buoyant platform having a generally rectangular shape, the buoyant platform may have the first end and the second end along the elongate axis and two peripheral sides. Furthermore, herein the one or more wave energy conversion devices may be divided (grouped) into the first subset and the second subset. The first subset of the one or more wave energy conversion devices may be clustered at one of the ends, say the first end of the buoyant platform with the second end of the buoyant platform having no wave energy conversion devices provided thereat. Furthermore, the second subset of the one or more wave energy conversion devices may be clustered at one or more peripheral sides, for example both peripheral sides, of the buoyant platform and may be substantially adjacent to the first subset. For example, if the energy converter may have a total of 9 wave energy conversion devices, the first subset may include 3 of those 9 wave energy conversion devices which may be arranged at the first end of the buoyant platform, and the second subset may include 6 of those 9 wave energy conversion devices which may further be divided into 2 groups of 3 wave energy conversion devices each and with one of the said 2 groups being clustered at one of the peripheral edge of the buoyant platform close to the first end so as to be adjacent to the first subset and other of the said 2 groups being clustered at other of the peripheral edge of the buoyant platform again close to the first end so as to be adjacent to the first subset. Such arrangement ensures that the buoyant platform is able to receive energy from the surrounding waves other than the incoming waves at the one or more wave energy devices, and thereby increase generation of electrical energy by the energy converter as discussed in more detail in the proceeding paragraphs.

Optionally, the buoyant platform is beneficially in a range of 3 metres to 100 metres in length. Optionally, the buoyant platform has a length-to-width ratio in a range of 2:1 to 10:1.

In the energy converter of the present disclosure, the buoyant platform together with its one or more wave energy conversion devices are configured to exhibit at least one of a roll movement and a pitch movement when in use, wherein natural resonant frequencies of at least one of the movements are matchable to a frequency of the ocean waves received at the energy converter. Herein, it may be appreciated that the roll movement may be rotational movement about the elongate axis, and the pitch movement may be rotational movement about an axis perpendicular to the elongate axis in a horizontal plane of the platform connecting the peripheral edges, of the energy converter including buoyant platform with the one or more wave energy conversion devices. As discussed, the buoyant platform may be designed so that it floats in the ocean when equipped with its one or more wave energy conversion devices. As ocean waves from the surrounding region of the one or more wave energy conversion devices start rocking the buoyant platform, forces of the ocean waves may cause the buoyant platform with its one or more wave energy conversion devices to move, for example at least one of pitch and roll. The buoyant platform together with its one or more wave energy conversion devices may have at least one of the roll movement and the pitch movement when in use. Natural resonant frequencies of at least one of the movements is matched to the frequency of the ocean waves received at the energy converter so that the buoyant platform together with its one or more wave energy conversion devices moves vigorously and generates more electrical energy as a result therefore, for example maximum electrical energy. It may be noted that in high ocean waves, the buoyant platform may have more pitch movement to optimize power uptake from the received ocean waves. In low ocean waves, the buoyant platform may have more roll movement to pick up energy of the ocean waves from surroundings. In the present embodiments, the roll movement and the pitch movement of the buoyant platform may follow a precession movement, which is a change in the orientation of the rotational axis of a rotating body; by exhibiting such a precession phenomenon enables the energy converter to achieve a natural movement thereof that enables the energy converter to generate electric power more efficiently using the energy of ocean waves received thereat.

Furthermore, in the energy converter of the present disclosure, the one or more wave energy conversion devices are configured to convert the energy of the ocean waves to oscillating water columns and further into air movements to drive a turbine coupled to a generator arrangement to generate electrical energy. It may be appreciated that the turbine and generator arrangement may be a machine used for converting mechanical movements to electrical energy. The turbine and generator arrangement may include an air turbine and an electrical generator. The turbine may be, but not limited to, an air-driven turbine, have blades that may be coupled to a shaft of the electric generator. As aforementioned, the buoyant platform together with its one or more wave energy conversion devices are configured to exhibit at least one of the roll movement and the pitch movement when in use. The movement of the buoyant platform together with its one or more wave energy conversion devices may cause air movements in the one or more wave energy conversion devices. The air movements may turn the blades of the turbine which in turn may drive the shaft of the electric generator to generate the electrical energy. The turbine is optionally an air turbine that is configured to have a uni-directional turbine rotation direction irrespective of air-flow direction therethrough.

It may be noted that when the ocean wave approaches the energy converter, two things may happen. Firstly, the ocean waves may go into the one or more wave energy conversion devices that may convert the energy of the waves into pressurized air and vacuums through a wave piston action. Secondly, surrounding ocean waves may start rocking the buoyant platform, making it have the roll movement and the pitch movement. The energy from these surrounding waves may be transferred via movement of the buoyant platform into the one or more wave energy conversion devices to create even more pressurized air and vacuums by adding energy to the wave piston actions. In this way, a shape and functionalities provided from this buoyant platform may potentially add a significant increase in electrical energy generation performance provided by the one or more wave energy conversion devices. It may be appreciated that a typical oscillation water column of the energy converter may be designed to pick up a spectrum of frequency 1:1 from the incoming waves. However, with the present design of the energy converter, an achievable power production may be boosted by using the buoyant platform that works as a point absorber to boost power. The present design is optimized to enable the buoyant platform to perform an energy transfer from surrounding waves into the wave energy conversion devices, to make a point absorber function as a power booster. Boosting power production in the energy converter by adding the energy of surrounding waves may increase power production by power boosting from a greater area of the ocean surface.

Optionally, the buoyant platform is configured to be dynamically tuneable to match the natural resonant frequencies of the energy converter to a frequency of the ocean waves surrounding the buoyant platform received at the energy converter when in use, to broaden absorption width substantially by point absorption to be able to convert energy received from the ocean waves surrounding the buoyant platform. It will be appreciated that the buoyant platform may be positioned at different sites of the ocean having different sea states. The ocean waves at different site may propagate in mutually different direction and may have different corresponding wave energy. Moreover, the same site of the ocean may have different sea states at different times. That is, at a given ocean site, the frequency of the ocean waves may differ with time. Thus, if the natural resonant frequencies of the buoyant platform are fixed and may even be matched with the frequency of ocean waves at a first time duration, the natural resonant frequencies of the buoyant platform may not match with the frequency of ocean waves at a second time duration due to change in sea state. Hence, in order to obtain maximum movement of the buoyant platform, the buoyant platform may be dynamically tuned to match the natural resonant frequencies to the frequency of the ocean waves received at the energy converter when in use. The tuning of the buoyant platform may be done in a number of ways. Optionally, by determining a function of energy generated relative to tuning of movement of the buoyant platform, a maximum resonance peal is determined that corresponds to maximum operating efficiency.

Optionally, the buoyant platform is tuned when in use by varying at least one of: a hull design of the buoyant platform, a weight of the buoyant platform, a depth of the buoyant platform when floating in an ocean in which ocean waves propagate, a width of the buoyant platform and a length of the buoyant platform. As discussed, the buoyant platform may be dynamically tuneable to match the natural resonant frequencies of the buoyant platform to the frequency of the ocean waves received at the energy converter when in use; for example, tuning can be implemented by varying a position of one or more moveable baffles (for example, one or more moveable fins) that are actuated and attached to the buoyant platform. Herein, a hull may be a portion of the buoyant platform that may be both in and on top of the surface of the ocean. The hull is usually (almost) symmetric to the centre-plane in geometry and mass distribution, and thus defining the hull design can be used to tune the buoyant platform. Similarly, the weight of the buoyant platform has an effect on its natural resonant frequency and can accordingly be defined to tune the buoyant platform. In a same way, the depth of the buoyant platform when floating in an ocean in which ocean waves propagate has an effect on its natural resonant frequency and can accordingly be adjusted to tune the buoyant platform; for example, the buoyant platform includes one or more water tanks whose water content can be transferred from one tank to another to change dynamically a weight distribution within the buoyant platform to tune its natural frequency of resonance in the ocean. Moreover, dimensions of the buoyant platform including its width and length have an effect on its natural resonant frequency and can accordingly be defined to tune the buoyant platform. It may be contemplated by a person skilled in the art that varying the aforesaid parameters has an effect on the natural frequency of a body, such as the buoyant platform, and thus can be accordingly defined (or adjusted) to allow for matching its natural resonant frequencies to the frequency of the ocean waves received at the energy converter when in use.

Optionally, the buoyant platform comprises a ballast tank for tuning a natural resonant frequency thereof, for example as aforementioned. The ballast tank may be a storage tank for storing fluids such as, but not limited to fresh water, salt water, brackish water and balancing the platform. The ballast tank may be used for tuning the natural resonant frequency of the buoyant platform so that the pitch movement and the roll movement may contribute to increase in energy uptake from the one or more wave energy conversion devices. In an embodiment, a motor may be associated with the ballast tank which is configured to pump in or pump out fluids, for example liquids, from the ballast tank for tuning the natural resonant frequency of the buoyant platform. The ballast tank may be implemented as the weight-inducing element for tuning said natural resonant frequency (as described earlier).

Optionally, the energy converter further comprises a gyroscopic arrangement that is configured to tune a natural resonant frequency of the buoyant platform together with its one or more wave energy conversion devices to match a frequency of the ocean waves. It may be appreciated that gyroscopic arrangement may be used for measuring, and thereafter controlling an orientation and an angular velocity of the buoyant platform. Herein, firstly, a frequency measuring device may measure the frequency of a given ocean wave and may send it to a computing device. The computing device may determine an orientation of the buoyant platform needed to match the natural resonant frequency of the buoyant platform together with its one or more wave energy conversion devices with the frequency of the given ocean wave. Furthermore, the gyroscopic arrangement may be implemented to measure a current orientation and a current angular velocity at which the buoyant platform is positioned in the ocean. The computing device may, then, determine a variation in angle needed according to the determined orientation so that the natural resonant frequency may match with the frequency of the ocean waves. According to the determined variation in angle needed, the angle of the buoyant platform may be changed by using any form of actuation arrangement known in the art to compensate for the determined variation in angle.

Optionally, the energy converter further comprises a mooring arrangement that is configured to allow for a rolling movement of the buoyant platform, to align the buoyant platform and its one or more wave energy conversion devices to receive the ocean waves thereby. Herein, the mooring arrangement may comprise mooring lines, anchors, connectors and the like for keeping the buoyant platform floating in the ocean. The mooring lines may be fibre ropes, wires, chains and the like that may be selected according to the sea state of the ocean. One end of the mooring lines may be connected to the buoyant platform and another end of the mooring lines may be connected to the anchors that may be positioned on an ocean floor of the ocean. When the mooring lines are connected to the buoyant platform and the anchors, the buoyant platform may float in ocean. The mooring arrangement may align the buoyant platform and its one or more wave energy conversion devices by using mooring lines, so that the buoyant platform and its one or more wave energy conversion devices may receive the ocean waves. In particular, as aforementioned, the buoyant platform may have the rolling movement when the ocean waves are received by the buoyant platform. The mooring arrangement may secure a 180 degrees movability towards a dominating wave direction, enabling an increase in energy uptake on different ocean waves and wind directions to achieved. In an embodiment, the energy converter may include a single point mooring arrangement with a 360 degrees free rotation about its own axis, with a power cable in middle of the mooring arrangement attached under the buoyant platform in a front end to secure an orientation of the energy converter towards a dominating wave direction. Such a single point mooring-arrangement is beneficial to implement as a fixed point below the energy converter, at a front end of the energy converter with three mooring lines holding the energy converter in place and with the power cable connected to a middle region of the buoyant platform. Such a mooring arrangement allows for a 360 degrees rotation in orientation of the energy converter, but with the energy converter staying positioned in the same spatial location in the ocean. Furthermore, in single point mooring arrangement with associated mooring lines connected to a centre region of the buoyant platform, the precession movement (as aforementioned) is susceptible to being achieved for the energy converter resulting in efficient energy generation thereby.

Optionally, the energy converter further comprises passive guiding fins arranged at least below the buoyant platform to control the roll movement and the pitch movement thereof. The passive guiding fins are included below the surface as an option to create desired direction and potential desired instability of the buoyant platform in order to provide more roll movement and pitch movement therefrom. Since, as discussed and may be contemplated, the more the roll movement and the pitch movement of the buoyant platform, the more is the electrical energy generated by the energy converter.

In some embodiments, the energy converter may further include upwardly-projecting wind turbines provided at the buoyant platform to enhance its instability to enhance rolling and pitching movements of the buoyant platform, and thereby help to increase generated electrical energy by the energy converter. In other embodiments, the energy converter may further include other types of renewable energy conversion devices, such as solar cells, solar concentrators and the like to utilize solar energy in order to heat up or spatially redistribute different liquids, which in turn are used to create instability of the buoyant platform, and thereby help to increase generated electrical energy by the energy converter. In still other embodiments, the energy converter may further include tidal turbines arranged below the buoyant platform to create tidal energy and cause instability of the buoyant platform, and thereby help to increase generated electrical energy by the energy converter.

Optionally, the energy converter further comprises a support structure connecting the buoyant platform to the one or more wave energy conversion devices, wherein the support structure defines spaces to collect floating-by waste brought thereinto by the ocean waves received at the energy converter. It may be appreciated that as the buoyant platform floats in the ocean, the buoyant platform may be exposed to waste materials such as, plastics floating in the ocean and brought by the ocean waves due to its natural placement in the path of the ocean waves. Such waste materials may be collected by the defined spaces, materials or collectors in the buoyant platform. In this way apart from generating the electrical energy, the buoyant platform may provide a passive functionality to assist in cleaning of the ocean and therefore improving a marine environment surrounding the energy converter for marine biota.

Optionally, the support structure along with the buoyant platform and the one or more wave energy conversion devices define in peripheral outline an octagonal shape. Such an octagonal shape is beneficial as it may help to provide enhanced strength and robustness to the overall energy converter, which in turn may help to increase its longevity in harsh ocean environments. The octagonal shape may further provide positional stability to the energy converter and help to keep the energy converter in a spatial position within an ocean environment. In an embodiment, the support structure, the buoyant platform and the one or more energy conversion devices may be made of steel and may be positioned in such a way that they form the octagonal shape. It may be noted that the support structure along with the buoyant platform and the one or more wave energy conversion devices may define in peripheral outline other shapes too, such as, a hexagonal shape, without departing from the spirit and the scope of the present disclosure.

Moreover, the present disclosure also relates to the method for using an energy converter for converting energy of ocean waves received at the energy converter into corresponding electrical energy as described above. The various embodiments and variants disclosed above apply mutatis mutandis to the present method. The method includes arranging for the energy converter to include a buoyant platform having a peripheral edge region. The method further includes mounting one or more wave energy conversion devices around at least a portion of the peripheral edge region. The method further includes configuring the buoyant platform together with its one or more wave energy conversion devices to exhibit at least one of a roll movement and a pitch movement when in use, wherein natural resonant frequencies of at least one of the roll movement and the pitch movement are matchable to a frequency of ocean waves received at the energy converter. The method further includes configuring the one or more wave energy conversion devices to convert the energy of the ocean waves to oscillating water columns and further into air movements to drive a turbine and generator arrangement to generate electrical energy. The buoyant platform allows to receive energy from a larger absorption region (surrounding waves) and not just incoming waves received at the energy converter and thus makes it possible to broaden an absorption width of the energy converter substantially by point absorption to get energy from the surrounding waves, and thereby increase generation of electrical energy achieved when using the energy converter.

Optionally, the method further includes arranging the buoyant platform to be elongate and to have a first end and a second end disposed along an elongate axis; and clustering a first subset of the one or more wave energy devices at one of the ends substantially along the elongate axis, and a second subset of the one or more wave energy devices at one or more peripheral sides of the buoyant platform and substantially adjacent to the first subset. Such an arrangement ensures that the buoyant platform is able to receive energy from the surrounding waves other than the incoming waves at the one or more wave energy devices, and thereby is able to increase generation of electrical energy provided by the energy converter.

Optionally, the method further includes configuring the buoyant platform to be dynamically tuneable to match the natural resonant frequencies to a frequency of the ocean waves surrounding the platform received at the energy converter when in use, to broaden absorption width substantially by point absorption to be able to convert energy received from the ocean waves surrounding the platform. The dynamic tuning of the buoyant platform to match the natural resonant frequencies to a frequency of the ocean waves surrounding the platform, helps to increase the generated electrical energy by the energy converter.

The energy converter and method of the present disclosure provide more efficient conversion of the energy of ocean waves received at the energy converter into corresponding electrical energy. The generated electrical energy is boosted by using the buoyant platform that acts as the point absorber to boost the power, by absorbing energy from surrounding waves and not just direct incoming waves as would have been the case when the energy converter may only have the wave energy conversion devices and not the buoyant platform. Extra energy is provided from movements of the buoyant platform to boost energy uptake by the one or more wave energy conversion devices. As a platform may anyways be needed in the energy converter, using the buoyant platform of the present disclosure boosts the generated electrical energy without significantly increasing its cost. Thus, the present energy converter is able to generate more electrical energy than traditional oscillation water columns (OWCs), point absorbers and the like without significantly increasing its cost. Moreover, the energy converter has longer durability, easier power transfer, optimized mooring arrangement, better survivability and longevity. Furthermore, the energy converter is more flexible towards clients as operation and maintenance of the energy converter is easier with easy access on back and on board; in other words, clustering the wave energy conversion devices towards a first end of the buoyant platform makes a second end of the buoyant platform more accessible for docking service boats for enabling personnel to access and service the wave energy converter. Furthermore, the buoyant platform may be scalable in width and size, for example as aforementioned. Moreover, the buoyant platform with the one or more wave energy conversion devices may have no movable parts in the ocean and all electro systems may be above ocean level. The energy converter may be built in packs or arrays to further enhance the generated electrical energy. The energy converter and the method may be used to electrify fish farming, oil and gas operations, harbours, coastal villages, coastal cities, coastal businesses, desalination-projects, hydrogen-projects, standby-ships, lighthouses, cities on sea, offshore charging stations, subsea operations and the like.

### DETAILED DESCRIPTION OF DRAWINGS

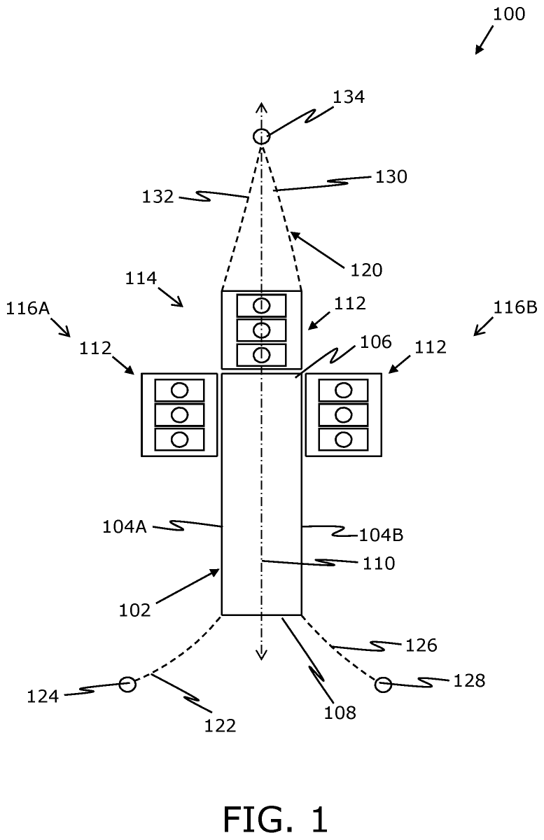

FIG. 1 is a schematic diagram of an energy converter 100 for converting an energy of ocean waves received at the energy converter 100 into corresponding electrical energy, in accordance with an embodiment of the present disclosure. The energy converter 100 includes a buoyant platform 102 having a peripheral edge region with a first peripheral side 104A and a second peripheral side 104B. The buoyant platform 102 is arranged to be elongate and to have a first end 106 and a second end 108 disposed along an elongate axis 110. The energy converter 100 includes one or more wave energy devices 112. A first subset 114 of the one or more wave energy devices 112 is clustered at the first end 106 substantially along the elongate axis 110, and a second subset 116A, 116B of the one or more wave energy devices 112 is clustered at the first peripheral side 104A and the second peripheral side 104B respectively of the buoyant platform 102, substantially adjacent to the first subset 114. The energy converter 100 further comprises a mooring arrangement 120. The mooring arrangement 120 includes a first mooring line 122 that connects the buoyant platform 102 to a first anchor 124, a second mooring line 126 that connects the buoyant platform 102 to a second anchor 128, and a third mooring line 130 and a fourth mooring line 132 that connects the buoyant platform 102 to a third anchor 134. The mooring arrangement 120 is configured to allow for a rolling movement of the buoyant platform 102 to align the buoyant platform 102 and its one or more wave energy conversion devices 112 to receive the ocean waves thereby.

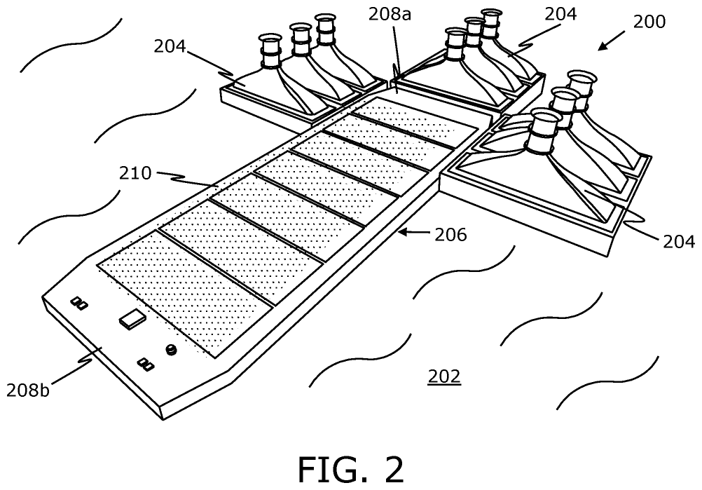

FIG. 2 is a diagrammatic illustration of an energy converter 200, in accordance with an embodiment of the present disclosure. In the illustrated examples, the energy converter 200 is shown to be implemented and floating in an ocean 202. The energy converter 200 includes one or more wave energy conversion devices 204. Herein, one or more wave energy conversion devices 204 are oscillating water columns. The energy converter 200 further includes a buoyant platform 206. The buoyant platform 206 has a first end 208a and a second end 208b, and a peripheral edge region 210. A first subset of the one or more wave energy devices 204 is clustered at the first end 208a, and a second subset of the one or more wave energy devices 204 is clustered at the peripheral edge region 210 respectively, substantially adjacent to the first subset, of the buoyant platform 102.

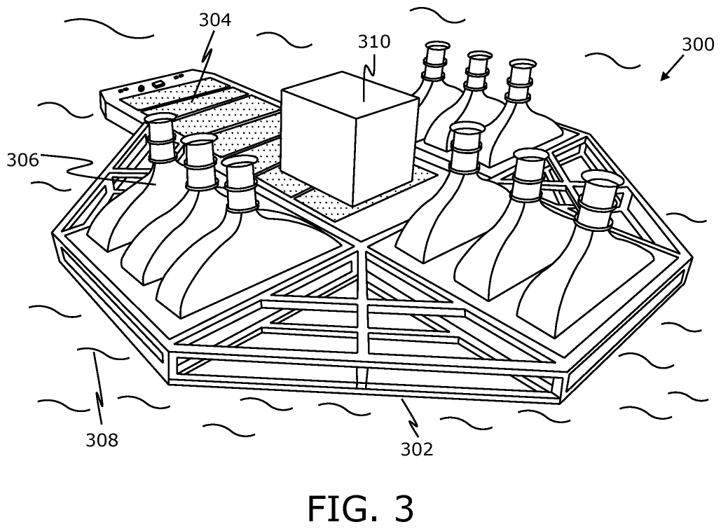

FIG. 3 is a diagrammatic illustration of an energy converter 300 comprising a support structure 302, in accordance with an embodiment of the present disclosure. The energy converter 300 includes a buoyant platform 304 and one or more wave energy conversion devices 306. The support structure 302 connects the buoyant platform 304 to the one or more wave energy conversion devices 306. Herein, the support structure 202 defines spaces to collect waste material brought thereinto by the ocean waves such as, an ocean wave 308 received at the energy converter 300. The energy converter 300 also includes a control room 310 provided at the buoyant platform 304 housing one or more of control arrangements, computing devices, energy storage units, etc. for controlling operations of the energy converter 300. It may be observed from FIG. 3 that the support structure along 302 with the buoyant platform 304 and the and one or more wave energy conversion devices 306 define in peripheral outline an octagonal shape.

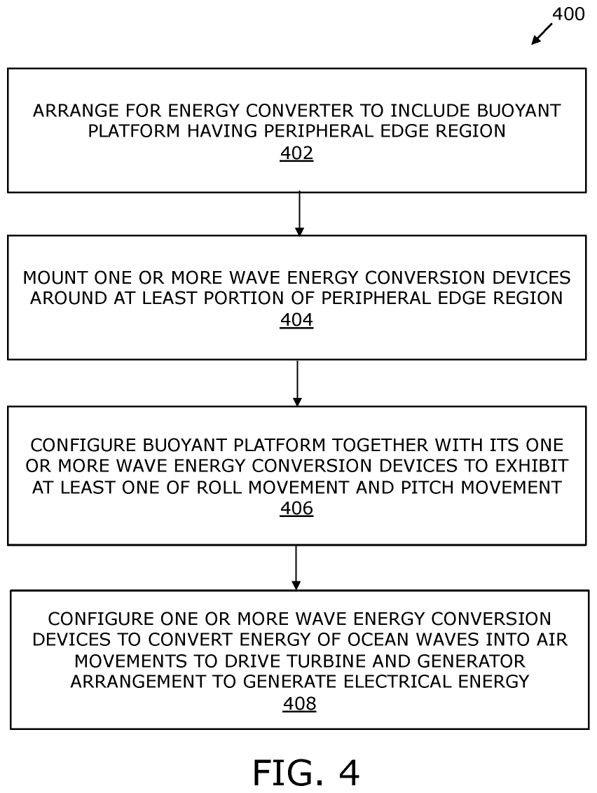

FIG. 4 is a flowchart listing steps involved in a method 400 for using an energy converter for converting energy of ocean waves received thereat into electrical energy, in accordance with an embodiment of the present disclosure; the energy converter is beneficially of a type as described in the foregoing. The method 400 includes, at a step 402, arranging for the energy converter to include a buoyant platform having a peripheral edge region. The method 400 includes, at a step 404, mounting one or more wave energy conversion devices around at least a portion of the peripheral edge region. The method 400 includes, at a step 406, configuring the buoyant platform together with its one or more wave energy conversion devices to exhibit at least one of a roll movement and a pitch movement when in use. Herein, natural resonant frequencies of at least one of the roll movement and the pitch movement are matchable to a frequency of ocean waves received at the energy converter. The method 400 includes, at a step 408, configuring the one or more wave energy conversion devices to convert the energy of the ocean waves to oscillating water columns and further into air movements to drive a turbine and generator arrangement to generate electrical energy.

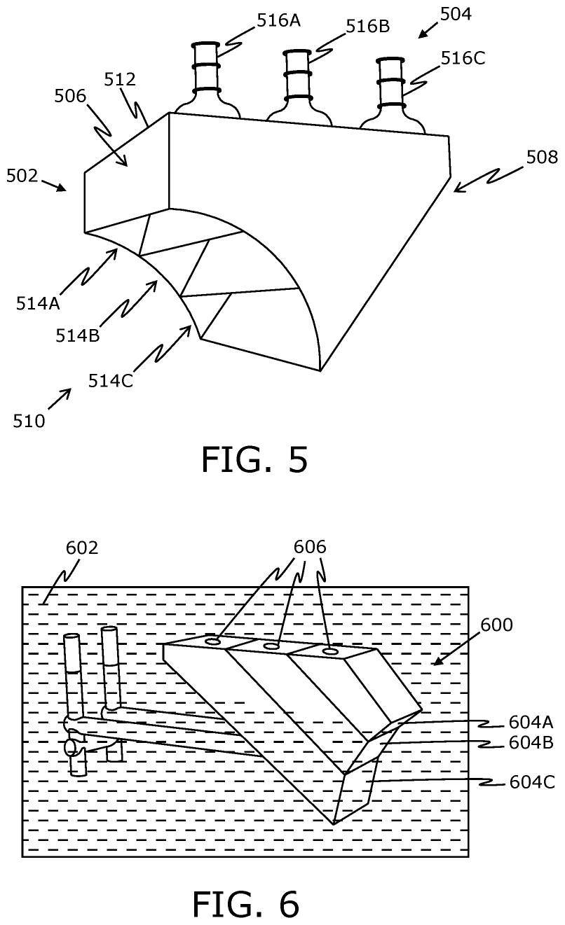

The aforementioned steps are only illustrative and other alternatives can also be provided where one or more steps are added, one or more steps are removed, or one or more steps are provided in a different sequence. FIG. 5 is a diagrammatic illustration of a placement of a chamber arrangement 502 and an air flow arrangement 504, in accordance with an embodiment of the present disclosure. As shown, the chamber arrangement 502 has a first side end 506, a second side end 508, an open lower end 510, and an upper end 512. The first side end 506 is a smaller side end of the chamber arrangement 502 as compared to the second side end 508. The open lower end 510 is at least partially submerged when in use in an ocean (not shown) in which ocean waves propagate. The upper end 512 has an opening (not shown) and being located above a surface of the ocean. The chamber arrangement 502 comprises three chambers 514A, 514B, and 514C that are formed between the first side end 506 and the second side end 508. The three chambers 514A-514C have varying depths and are arranged adjacent to each other in an order of increasing depths along a direction from the first end 506 to the second end 508. The air flow arrangement 504 comprises three air ducts 516A, 516B, and 516C. A given air duct has an open top end (not shown) that is exposed to atmosphere, an open bottom end (not shown), and an air turbine (not shown) that is arranged between the open top end and the open bottom end. The air flow arrangement 504 is shown to be placed on top of the chamber arrangement 502 in a manner that the opening of the upper end 512 is fluidically coupled to the open bottom end. Movements of ocean waves produce an oscillating water column within the chamber arrangement 502 thereby generating air movements inside the air flow arrangement 504 to drive the air turbine, for generating the electrical energy.

FIG. 6 is a diagrammatic illustration of a chamber arrangement 600, in accordance with an embodiment of the present disclosure. As shown the chamber arrangement 600 is partially submerged in an ocean 602. The chamber arrangement 600 comprises three chambers 604A, 604B, and 604C. The three chambers 604A-604C have varying depths. The three chambers 604A-604C have three damping plates 606 placed thereon.

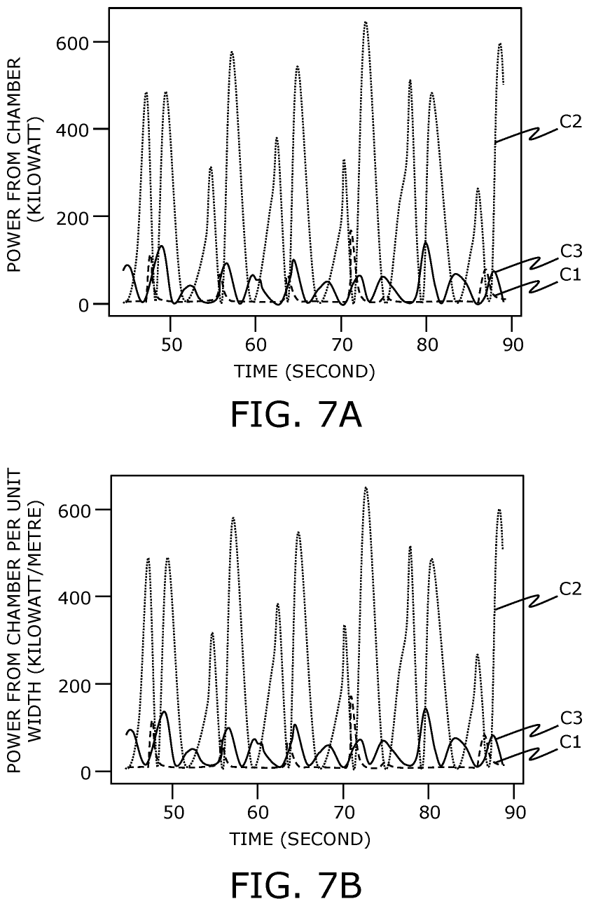

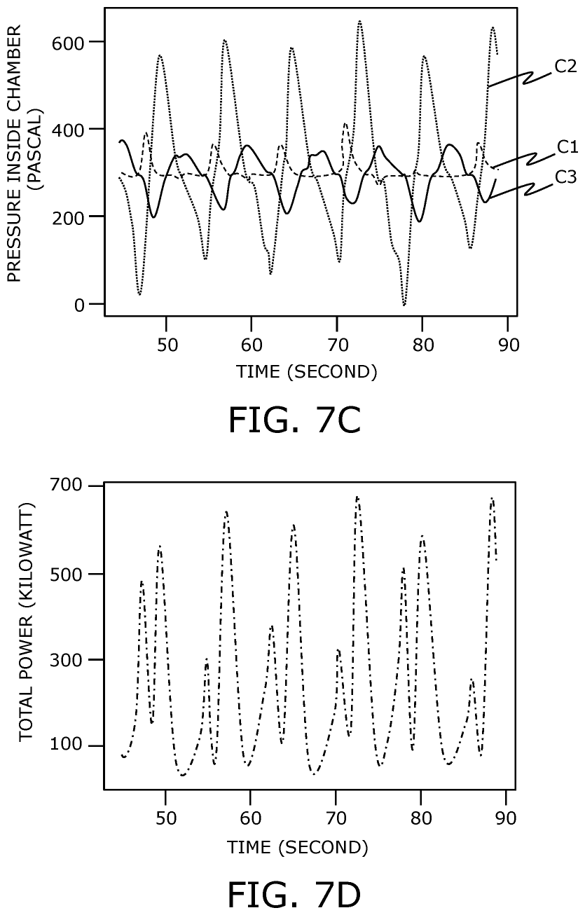

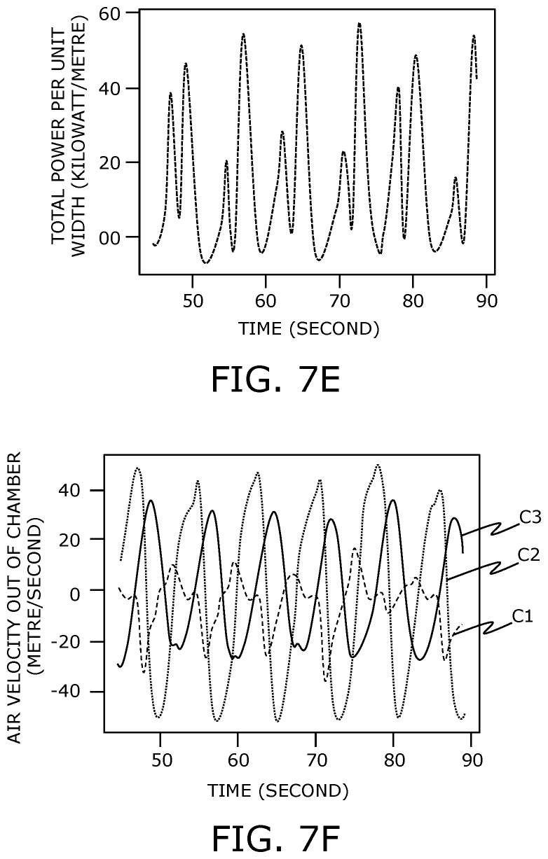

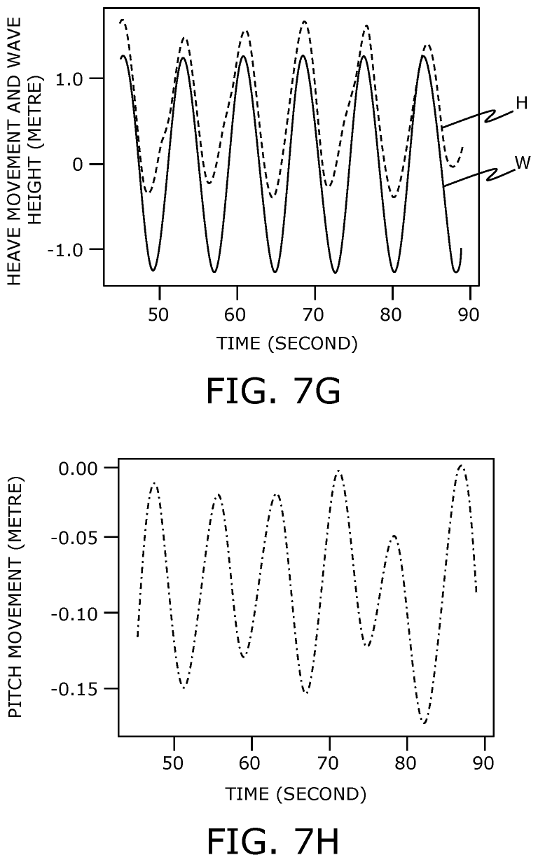

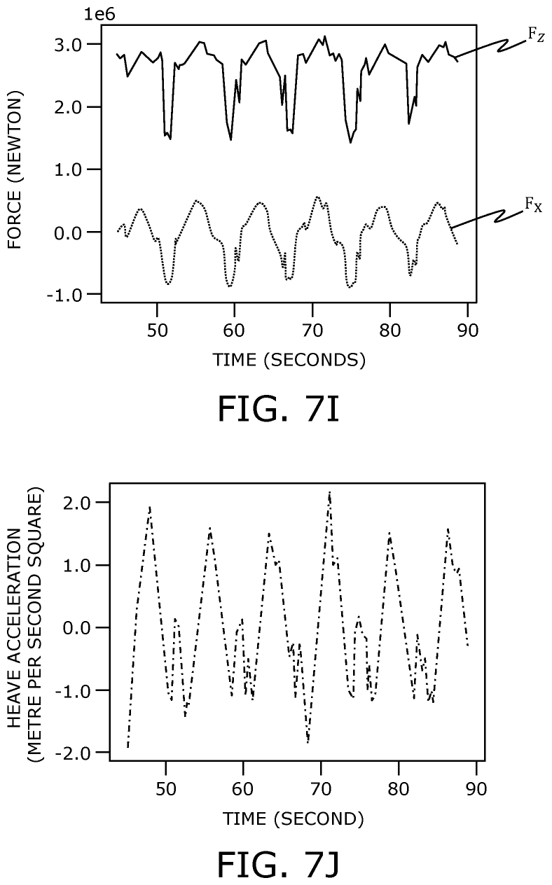

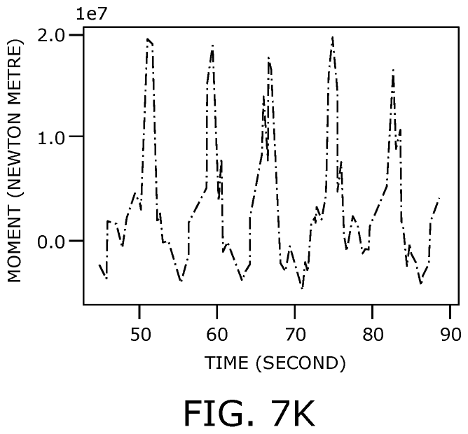

FIGS. 7A-7K are discussed in the experimental part below.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

### Experimental Part

Hereinbelow, there are provided results and discussion of computational flow dynamics (CFD) simulations performed for a chamber arrangement of a wave energy conversion device of an energy converter of the present disclosure. The CFD simulations were performed at least to: employ advanced CFD tools on a performance for the chamber arrangement, observe a behaviour of the wave energy conversion device in ocean waves, calculate pressures inside different chambers of the chamber arrangement for structural dimensioning, determine estimates of power production for dimensioning of power take-off (PTO) system, determine estimates of flow speed for turbine sizing, determine different types of forces for mooring design.

Said simulations utilize various geometries, sizes, and natural periods of a buoyant platform and three chambers (C1, C2, and C3) of the chamber arrangement. Herein, 7 different CFD simulations were performed by considering impacts of 5 regular ocean waves and 2 irregular ocean waves on the performance of the chamber arrangement. Performance of the of the chamber arrangement is analysed by simulating the regular ocean waves with a wave height of 2.5 metres and a wave period ranging from 5.8 seconds to 10.6 seconds, and the irregular ocean waves with a wave height (H) of 1.75 metres and a wave period (T) ranging from 7.8 seconds to 10.6 seconds. The aforesaid ranges of the wave periods were selected, based on a natural period (namely, a natural frequency) of a given chamber. For simulation purposes, three wave periods were taken same as natural periods of the chambers, and two wave periods were taken different than natural periods of the chambers. The wave energy conversion device is installed on a floating structure that is semi-submersible. Such a structure is very soft and has high natural periods. This allows said structure to have a low response in short ocean waves, and hence there is a high relative motion between water surface and the chambers.

For the CFD simulations, calculated natural periods for the buoyant platform in a heave direction, a pitch direction, and a rolling direction were 8 seconds, 10.5 seconds, and 15 seconds. The aforesaid natural periods were uncertain as added mass (of water) inside the chambers is not accounted for in the aforesaid calculation. Moreover, the natural periods of the chambers C1, C2, and C3 were 5.8 seconds, 7.8 seconds, and 10.6 seconds, respectively. Furthermore, for the CFD simulations, a radius of a hole on a top of each chamber were reduced to simulate an effect of an air turbine arranged in an air duct of an air flow arrangement. The radius of the hole used in the CFD simulation is 0.75 metres which corresponds to a turbine of a diameter of approximately 2 metres. Such a hole will give a linear damping effect, and a power from each chamber is calculated by taking a volume flow of air out of said hole inside each chamber multiplied by a pressure inside each chamber. It will be appreciated that geometries of the chamber arrangement used in the CFD simulations could be modified when a fabrication of the chamber arrangement is carried. In this regard, some geometrical parameters could be modified to add buoyancy at a desired position in the chamber arrangement. Also, pipe sizes and joints between pipes could be improved for ease in fabrication.

Mean total power, mean total power per metre, and incoming energy were calculated using following formulae:

$$\begin{matrix}{P}_{w} = \frac{ρ {g}^{2} {H}_{s}^{2} {T}_{e}}{64 π} \\ {P}_{i n} = \frac{{c}_{g} ρ g {H}^{2}}{8} \approx 976 {TH}^{2} \\ {T}_{e} = 1.2 {T}_{z} \\ {T}_{p} = 1.4 {T}_{z}\end{matrix}$$

Herein, P_{w} refers to the incoming irregular wave energy (in kilowatts per metre), p refers to the mass density of a chamber arrangement (in kilograms per cubic metre), g refers to acceleration due to gravity (i.e., the gravitational constant in metres per square second), Hₛ refers to the significant wave height (in metres), Tₑ refers to the wave energy period (in seconds), Pᵢₙ refers to the incoming regular wave energy (in kilowatts per metre), C_{g} refers to the group velocity (in metres per second), H refers to the wave height of a specific ocean wave (in metres), T refers to the wave period (in seconds), T_{z} refers to the mean zero up-crossing period (in seconds), and Tₚ refers to the peak period (in seconds). The significant wave height, Hₛ, is the average height (namely, the mean height) of the highest three ocean waves.

Below mentioned are wave heights and wave periods that were utilized for the 7 different CFD simulations.

### Regular Ocean Waves:

H=2.5 metres, T=7.8 seconds=a natural period of the chamber C2
H=2.5 metres, T=10.6 seconds=a natural period of the chamber C3
H=2.5 metres, T=5.8 seconds=a natural period of the chamber C1
H=2.5 metres, T=9.2 seconds
H=2.5 metres, T=6.8 seconds

### Irregular Ocean Waves:

H=1.75 metres, T=7.8 seconds=a natural period of the chamber C2
H=1.75 metres, T=10.6 seconds=a natural period of the chamber C3

Out of the aforesaid 7 CFD simulations, parameters for 6 CFD simulations are listed in Tables 1A, 1B, and 1C, and a summary of results regarding energy conversion is provided in Tables 2A and 2B hereinbelow.

TABLE 1A

| | | | | Mass of | Length of |
|---|---|---|---|---|---|
| | | Wave | Wave | buoyant | buoyant |
| | Type of | height, | period, | platform, | platform, |
| Simulation | ocean | H or Hs | Tp | M | L |
| no. | waves | (m) | (s) | (kg) | (m) |
| 1 | Regular | 2.5 | 7.8 | 586328 | 15 |
| 2 | Regular | 2.5 | 10.6 | 586328 | 15 |
| 3 | Regular | 2.5 | 5.8 | 586328 | 15 |
| 4 | Irregular | 1.75 | 7.8 | 586328 | 15 |
| 5 | Regular | 2.5 | 9.2 | 586328 | 15 |
| 6 | Regular | 2.5 | 6.8 | 586328 | 15 |

TABLE 1B

| | Centre of | Centre of | Centre of | Moment of |
|---|---|---|---|---|
| | gravity | gravity | gravity | inertia |
| | along | along | along | along |
| | X-axis, | Y-axis, | Z-axis, | X-axis, |
| Simulation | COGx | COGy | COGz | Ix |
| no. | (m) | (m) | (m) | (kgm²) |
| 1 | 18.96 | 0 | 8.5 | 1.31E+07 |
| 2 | 18.96 | 0 | 8.5 | 1.31E+07 |
| 3 | 18.96 | 0 | 8.5 | 1.31E+07 |
| 4 | 18.96 | 0 | 8.5 | 1.31E+07 |
| 5 | 18.96 | 0 | 8.5 | 1.31E+07 |
| 6 | 18.96 | 0 | 8.5 | 1.31E+07 |

TABLE 1C

| | Moment of | Moment of | |
|---|---|---|---|
| | inertia | inertia | |
| | along | along | |
| | Y-axis, | Z-axis, | |
| Simulation | Iy | Iz | Speed |
| no. | (kgm²) | (kgm²) | (in knot) |
| 1 | 1.63E+08 | 1.63E+08 | 0 |
| 2 | 1.63E+08 | 1.63E+08 | 0 |
| 3 | 1.63E+08 | 1.63E+08 | 0 |
| 4 | 1.63E+08 | 1.63E+08 | 0 |
| 5 | 1.63E+08 | 1.63E+08 | 0 |
| 6 | 1.63E+08 | 1.63E+08 | 0 |

TABLE 2A

| | | Wave | Wave | Mean |
|---|---|---|---|---|
| | Type of | height, | period | total |
| Simulation | ocean | H or Hs | T/Tp | power |
| no. | waves | (m) | (s) | (kW) |
| 1 | Regular | 2.5 | 7.8 | 238.28 |
| 2 | Regular | 2.5 | 10.6 | 57.15 |
| 3 | Regular | 2.5 | 5.8 | 75.77 |
| 4 | Irregular | 1.75 | 7.8 | 19.47 |
| 5 | Regular | 2.5 | 9.2 | 159.58 |
| 6 | Regular | 2.5 | 6.8 | 206.84 |

TABLE 2B

| | Mean total | | |
|---|---|---|---|
| | power | Incoming | |
| Simulation | per metre | Energy | Utilization |
| no. | (kW) | (kW/m) | (%) |
| 1 | 23.36 | 47.88 | 49 |
| 2 | 5.60 | 65.07 | 9 |
| 3 | 7.43 | 35.60 | 21 |
| 4 | 1.91 | 9.97 | 19 |
| 5 | 11.86 | 56.47 | 21 |
| 6 | 20.28 | 41.74 | 49 |

Based on the conducted CFD simulations, it was also observed that:
for regular ocean waves with short time periods, an energy conversion of approximately 50 percent is feasible;
a front chamber (i.e., the chamber C1) is not very active in energy conversion for most of the CFD simulations, since it is partially ventilated (namely, partially submerged) in ocean waves for a considerable amount of time;
CFD simulation in which wave period is considerably high (for example, in the CFD simulation 2) shows that an entirety of the energy converter moves with the ocean waves, which produces relative motion between the ocean waves and the three chambers, and thus results in a reduced energy conversion;
a maximum pressure inside the chamber C2 was 7055 Pascal (Pa) for the CFD simulation 1;
a highest flow speed inside the chamber C2 was 49.11 metres per second (m/s) in the CFD simulation 1;
a maximum power of 643 kilowatt (KW) was generated for the chamber C2 in the CFD simulation 1, and a turbine efficiency of 50 percent resulted in 321 kW power on a generator shaft. This could be a basis for dimensioning of the generator shaft and the PTO system with a required margin of safety;
the CFD simulation 6 showed an average drag force of 94.3 Kilonewton (kN) which is highest amongst all CFD simulations;
an entirety of the energy converter pitches up in front, which is likely due to an internal pressure generated inside the chambers that is capable of lifting the energy converter up in front. Moreover, the internal pressure acts asymmetrically when the oceans waves are pushed inside the chambers as compared to when the ocean waves fell outside the chambers;
a drag force on the wave energy converter device could be a reason for pitch angle increment;
all drag forces acts above a centre of gravity (COG)-point whereupon mass of the entirety of the energy converter is fixed, and hence a pitch moment is produced;
since a waterplane area of the wave energy converter is small in aft, large pitch angles were produced as the aft sunk down to counteract a pressure force from the wave energy converter device;
a stiffness in pitch is increased and/or a structural design of the wave energy converter device is improvised, such that a COG-point of the wave energy converter device is greater from a centre of buoyancy point of the wave energy converter device;
due to a pitching motion, the chamber C1 comes out of the water and is ventilated to an atmospheric pressure, thereby reducing an overall power conversion;
increasing a depth of the chamber C1 facilitates in increasing the power conversion but could change a natural period of the chamber C1, so improving the pitch angle in such a case is beneficial;
a total power conversion is very low in the CFD simulation 2, as there is minimal relative motion between water surface inside the chambers and a structure of the wave energy converter, thereby producing low pressure and volume flow inside the chambers;
an increased natural period in heave and pitch motions (for example, by way of adding weight-inducing element such as damping plates and/or a ballast tank) would make the chamber C3 perform a lot better and probably at a same level as that of the chamber C2 in terms of energy conversion; and
for a large wave oscillation, an internal sloshing inside the chambers is observed. This is generally not desired, but it does not considerably influence power conversion.

As an example, there will now be discussed graphical illustrations for different performance parameters used in the CFD simulation 1. Referring to FIGS. 7A-7K, illustrated are variations of different performance parameters with respect to time, the different performance parameters being used in computational flow dynamics (CFD) simulations performed for a chamber arrangement of a wave energy conversion device of an energy converter of the present disclosure.

In FIG. 7A, a variation of power (in kilowatt) generated from different chambers with respect to time (in seconds) is graphically illustrated. Herein, a variation of power generated from a first chamber is depicted using a dashed line C1, a variation of power generated from a second chamber is depicted using a dotted line C2, and a variation of power generated from a third chamber is depicted using a solid line C3.

In FIG. 7B, a variation of power (in kilowatt) generated from a chamber per unit width of the chamber with respect to time (in seconds) is graphically illustrated. Herein, a variation of power generated from a first chamber per unit width of the first chamber is depicted using a dashed line C1, a variation of power generated from a second chamber per unit width of the second chamber is depicted using a dotted line C2, and a variation of power generated from a third chamber per unit width of the third chamber is depicted using a solid line C3.

In FIG. 7C, a variation of pressure (in Pascal) generated inside different chambers with respect to time (in seconds) is graphically illustrated. Herein, a variation of pressure inside a first chamber is depicted using a dashed line C1, a variation of pressure generated inside a second chamber is depicted using a dotted line C2, and a variation of pressure generated from a third chamber is depicted using a solid line C3.

In FIG. 7D, a variation of a total power (in kilowatt) generated collectively from a plurality of chambers with respect to time (in seconds) is graphically illustrated. The variation of the total power is depicted using a dash-dot line. Herein, the total power is maximum at around 72 seconds, and is approximately equals to 700 kilowatts.

In FIG. 7E, a variation of a total power per unit width of a chamber (in kilowatt/metre) with respect to time (in seconds) is graphically illustrated. The variation of the total power per unit width of the chamber is depicted using a dashed line. Herein, the total power per metre width of the chamber is maximum at around 72 seconds, and is approximately equals to 58 kilowatts per metre.

In FIG. 7F, a variation of air velocity (in metre per second) out of different chambers is graphically illustrated. Herein, a variation of air velocity out of a first chamber is depicted using a dashed line C1, a variation of air velocity out of a second chamber is depicted using a dotted line C2, and a variation of air velocity out of a third chamber is depicted using a solid line C3.

In FIG. 7G, a variation of a heave movement (in metre) of a chamber arrangement of an energy converter and a variation of a wave height (in metre) with respect to time (in seconds) is graphically illustrated. The variation of the heave movement of the chamber arrangement is depicted using a dashed line H, whereas the variation of the wave height is depicted using a solid line W.

In FIG. 7H, a variation of a pitch movement (in metre) of a chamber arrangement of an energy converter with respect to time (in seconds) is graphically illustrated. Said variation is depicted using a dash-dot line. Herein, the pitch movement is minimum in a range of 80 seconds to 90 seconds, and is approximately lying between −0.15 to −0.20.

In FIG. 7I, a variation of forces (in newton) acting upon of a chamber arrangement of an energy converter with respect to time (in seconds) is graphically illustrated. Herein, a variation of a drag force is depicted using a dotted line Fx, whereas a variation of a heave force is depicted using a solid line Fz.

In FIG. 7J, a variation of a heave acceleration (metre per second square) of a chamber arrangement of an energy converter with respect to time (in seconds) is graphically illustrated. Herein, a variation of a drag force is depicted using a dash dot line. Said variation shows both a positive heave acceleration and a negative heave acceleration (i.e., heave deceleration) with respect to time.

In FIG. 7K, a variation of a moment (in newton metre) about a vertical axis (for example, such as Y-axis) of a chamber arrangement of an energy converter from a centre of gravity (COG) of the chamber arrangement with respect to time (in seconds) is graphically illustrated. Said variation is depicted using a dash dot line.

1. An energy converter comprising one or more wave energy conversion devices implemented for converting an energy of ocean waves received thereat into electrical energy, the energy converter comprising:
a buoyant platform having a peripheral edge region,
wherein:
the one or more wave energy conversion devices are mounted around at least a portion of the peripheral edge region,
the buoyant platform together with its one or more wave energy conversion devices are configured to exhibit at least one of a roll movement and a pitch movement when in use, wherein natural resonant frequencies of at least one of the movements are matchable to a frequency of the ocean waves received at the energy converter, and
the one or more wave energy conversion devices are configured to convert the energy of the ocean waves to oscillating water columns and further into air movements to drive a turbine and generator arrangement to generate electrical energy.

2. The energy converter according to claim 1, wherein the buoyant platform is arranged to be elongate and to have a first end and a second end disposed along an elongate axis, and wherein a first subset of the one or more wave energy devices is clustered at one of the ends substantially along the elongate axis, and a second subset of the one or more wave energy devices is clustered at one or more peripheral sides of the buoyant platform and substantially adjacent to the first subset.

3. The energy converter according to claim 1, wherein the buoyant platform is configured to be dynamically tuneable to match the natural resonant frequencies to a frequency of the ocean waves surrounding the platform received at the energy converter when in use, to broaden absorption width substantially by point absorption to be able to convert energy received from the ocean waves surrounding the buoyant platform.

4. The energy converter according to claim 3, wherein the buoyant platform is tuned when in use by varying at least one of:
(i) a hull design of the buoyant platform;
(ii) a weight of the buoyant platform;
(iii) a depth of the buoyant platform when floating in an ocean in which ocean waves propagate;
(iv) a width of the buoyant platform; and
(v) a length of the buoyant platform.

5. The energy converter according to claim 3, wherein the buoyant platform (102, 206, 304) comprises a ballast tank for tuning a natural resonant frequency thereof.

6. The energy converter according to claim 3, wherein the energy converter further comprises a gyroscopic arrangement that is configured to tune a natural resonant frequency of the buoyant platform together with its one or more wave energy conversion devices to match a frequency of the ocean waves.

7. The energy converter according to claim 1, wherein the energy converter further comprises a mooring arrangement that is configured to allow for a rolling movement of the buoyant platform, to align the buoyant platform and its one or more wave energy conversion devices to receive the ocean waves thereby.

8. The energy converter according to claim 1, wherein the energy converter further comprises passive guiding fins arranged at least below the buoyant platform to control the roll movement and the pitch movement thereof.

9. The energy converter according to claim 1, wherein the energy converter further comprises a support structure connecting the buoyant platform to the one or more wave energy conversion devices, wherein the support structure defines spaces to collect floating by waste brought thereinto by the ocean waves received at the energy converter.

10. The energy converter according to claim 9, wherein the support structure along with the buoyant platform and the one or more wave energy conversion devices define in peripheral outline an octagonal shape.

11. The energy converter according to claim 1, wherein at least one of the one or more wave energy conversion devices includes:
a chamber arrangement having a first side end, a second side end, an open lower end that is at least one partially submerged when in use in an ocean in which the ocean waves propagate, and an upper end that is located above a surface of the ocean, the upper end having at least one opening, and
an air flow arrangement comprising a plurality of air ducts, each air duct having an open top end that is exposed to atmosphere, an open bottom end, and an air turbine that is arranged between the open top end and the open bottom end,
wherein the air flow arrangement is placed on top of the chamber arrangement in a manner that the at least one opening is fluidically coupled to open bottom ends of the plurality of air ducts, and wherein movements of the ocean waves produce an oscillating water column within the chamber arrangement thereby generating air movements inside the air flow arrangement to drive air turbines arranged in the plurality of ducts for generating the electrical energy.

12. The energy converter according to claim 11, wherein the chamber arrangement comprises a plurality of chambers formed between the first side end and the second side end, the plurality of chambers having varying depths and being arranged adjacent to each other in an order of increasing depths along a direction from the first end to the second end, and wherein each chamber has a corresponding air duct placed thereon.

13. The energy converter according to claim 11, wherein a geometric profile of the open lower end of the chamber arrangement is one of: a linear profile, a step profile, a parabolic profile, a logarithmic profile, a freeform profile.

14. The energy converter according to claim 11, wherein the energy converter comprises a plurality of wave energy conversion devices that are arranged along the peripheral edge region of the buoyant platform in form of a one-dimensional array, and wherein second side ends of chamber arrangements of the plurality of energy conversion devices are arranged proximal to the buoyant platform and first side ends of the plurality of chamber arrangements are arranged far from the buoyant platform.

15. The energy converter according to claim 1, further comprising a weight-inducing element for tuning a natural resonant frequency of the buoyant platform, the weight-inducing element being implemented as at least one of: a damping plate, a ballast tank.

16. A method for using an energy converter comprising one or more wave energy conversion devices implemented for converting an energy of ocean waves received thereat into electrical energy, the method comprises:
arranging for the energy converter to include a buoyant platform having a peripheral edge region;
mounting the one or more wave energy conversion devices around at least a portion of the peripheral edge region;
configuring the buoyant platform together with its one or more wave energy conversion devices to exhibit at least one of a roll movement and a pitch movement when in use, wherein natural resonant frequencies of at least one of the roll movement and the pitch movement are matchable to a frequency of the ocean waves received at the energy converter; and
configuring the one or more wave energy conversion devices to convert the energy of the ocean waves to oscillating water columns and further into air movements to drive a turbine and generator arrangement to generate electrical energy.

17. The method according to claim 16, further comprising:
arranging the buoyant platform to be elongate and to have a first end and a second end disposed along an elongate axis; and
clustering a first subset of the one or more wave energy devices at one of the ends substantially along the elongate axis, and a second subset of the one or more wave energy devices at one or more peripheral sides of the buoyant platform and substantially adjacent to the first subset.

18. The method according to claim 16, further comprising configuring the buoyant platform to be dynamically tuneable to match the natural resonant frequencies to a frequency of the ocean waves surrounding the platform received at the energy converter when in use, to broaden absorption width substantially by point absorption to be able to convert energy received from the ocean waves surrounding the platform.
